(19) United States
(12) Patent Application Publication
(10) Pub. No.: US 2025/0101195 A1
(43) Pub. Date: Mar. 27, 2025

(54) Method For Depolymerizing A Polymer Into Reusable Raw Material

(71) Applicant: Ioniqa Technologies B.V., Eindhoven (NL)

(72) Inventors: Egor Vasilyevich FUFACHEV, Utrecht (NL); Joost Robert WOLTERS, Waalre (NL)

(73) Assignee: Ioniqa Technologies B.V., Eindhoven (NL)

(21) Appl. No.: 18/728,328

(22) PCT Filed: Jan. 12, 2023
(86) PCT No.: PCT/NL2023/050009

§ 371 Date: Jul. 11, 2024

(30) Foreign Application Priority Data
Jan. 7, 2022 (NL) 2030566

(51) Int. Cl. C08J 11/18

(52) U.S. Cl. CPC C08J 11/18; C08J 2331/06

(57) ABSTRACT

The present invention relates to a method for obtaining a monomer by degrading a polymer, the polymer being a homo or copolymer of the monomer, the method comprising the steps of providing the polymer and a solvent as a reaction mixture in a reactor, wherein the solvent is a reactant capable of reacting with the polymer to degrade the polymer into oligomers and at least one monomer; providing a reusable catalyst being capable of degrading the polymer into oligomers and at least one monomer; degrading the polymer in the reaction mixture at reaction conditions using the catalyst to form a monomer; and recovering the catalyst from the reaction mixture; wherein the method further comprises the addition of a base to at least one of the reaction steps. The present invention furthermore relates to the use of a base as a co-catalyst for a catalyst for degrading a polymer in a reaction mixture at reaction conditions.

### FIELD OF INVENTION

The invention relates to a method of depolymerizing a polymer into reusable raw material, such as for instance terephthalate monomer and oligomers, using a catalyst. The invention further relates to recovering the catalyst from the reaction mixture. The invention also relates to using a base as a co-catalyst in depolymerization reactions that use the catalyst.

### BACKGROUND

The depolymerization of a polymer into reusable raw material is currently an area of high interest to industry. One of the examples of a group of polymers that is of interest for recycling is terephthalate polymers, a group of polyesters comprising terephthalate in the backbone. The most common example of a terephthalate polymer is polyethylene terephthalate, also known as PET.

Alternative examples include polybutylene terephthalate, polypropylene terephthalate, polyethylene isophthalate, poly pentaerythrityl terephthalate and copolymers thereof, such as copolymers of ethylene terephthalate and polyglycols, for instance polyoxyethylene glycol and poly(tetramethylene glycol) copolymers. PET is one of the most common polymers and it is highly desired to recycle PET by depolymerization thereof into reusable raw material.

One preferred way of depolymerization is glycolysis, which is preferably catalyzed. Typically, as a result of the use of an alcohol such as ethylene glycol, a reaction mixture comprising at least one monomer comprising bis(2-hydroxyethyl) terephthalate (BHET) may be formed. One example of a suitable depolymerization by glycolysis is known from WO2016/105200 in the name of the present applicant. According to this process, the terephthalate polymer is depolymerized by glycolysis in the presence of a catalyst. At the end of the depolymerization process, water is added, and a phase separation occurs. This enables to separate a first phase comprising the BHET monomer from a second phase comprising catalyst, oligomers and additives. The first phase may comprise impurities in dissolved form and as dispersed particles. The BHET monomer can be obtained in a pure form by means of crystallization.

A high purity is required for reuse of the depolymerized raw material. As is well-known, any contaminant may have an impact on the subsequent polymerization reaction from the raw materials. Moreover, since terephthalate polymers are used for food and also medical applications, strict rules apply so as to prevent health issues.

While applicant's process according to WO2016/105200 leads to a very high conversion of the terephthalate polymer and also facilitates separation of various additives from the BHET monomer, the depolymerization reaction may further be optimized. Furthermore, the recovery of the catalyst from the reaction mixture may further be improved.

### SUMMARY

There is thus a need for providing a process of depolymerizing a polymer into reusable raw material having a high purity, such that it is suitable for preparation of fresh polymer. One of the examples is terephthalate polymer. Although such a process may not always yield a very high conversion of the polymer, acceptable conversion (rates) may be achieved. To improve conversion rates, catalysts are being used. These catalysts are separated from the monomer and re-used after separation. It is an aim of the present invention to further improve the catalytic depolymerisation process and to further improve separation and recovering of the catalyst.

According to a first aspect of the invention there is provided a method for obtaining a monomer by degrading a polymer, the polymer being a homo or copolymer of the monomer, the method comprising the steps of
a. providing the polymer and a solvent as a reaction mixture in a reactor, wherein the solvent is a reactant capable of reacting with the polymer to degrade the polymer into oligomers and at least one monomer;
b. providing a reusable catalyst being capable of degrading the polymer into the oligomers and the at least one monomer; and
c. degrading the polymer in the reaction mixture at reaction conditions using the catalyst to form the at least one monomer; and
d. recovering the catalyst from the reaction mixture;
wherein the method further comprises the addition of at least one base to the reaction mixture in at least one of the reaction steps a to d.

According to a second aspect of the invention, the invention relates to the use of a base as a co-catalyst for the catalyst for degrading the polymer in the reaction mixture at reaction conditions.

### DETAILED DESCRIPTION OF THE INVENTION

Unless otherwise defined, all technical and scientific terms used herein have the same meaning as commonly understood by one of ordinary skill in the art which this invention belongs to. The terminology used in the description of the invention herein is for the purpose of describing particular embodiments only and is not intended to be limiting of the invention.

The present invention is a method for obtaining a monomer by degrading a polymer, the polymer being a homo or copolymer of the monomer. A reusable catalyst being capable of degrading the polymer into oligomers and at least one monomer is being used. To recover the catalyst more easily and to a higher extend, at least one base is being added to the reaction mixture in at least one of the reaction steps a to d. It has further been established that the base improves the catalytic degrading of the polymer into smaller molecules when added to the reaction mixture in or before step c. Reaction times and selectivity are improved.

The polymer and a solvent as a reaction mixture are provided in a reactor, wherein the solvent is a reactant capable of reacting with the polymer to degrade the polymer into oligomers and at least one monomer. Depolymerisation of polyesters occurs more preferably by means of solvolysis, wherein the solvent acts as reactant. Typical solvents are alkanols and alkanediols, such as ethylene glycol, methanol, diethylene glycol, propylene glycol, dipropylene glycol. Ethylene glycol has been found suitable in view of its physical properties (such as the boiling point around 200° C.). For the depolymerisation of PET, the use of ethylene glycol leads to bis(2-hydroxyethyl) terephthalate (BHET) as primary depolymerisation product. Dimers, trimers and further oligomers may also be obtained. BHET as well as its dimer may be purified and obtained by crystallisation in sufficient purity. One method thereof resides in the processing of the aqueous phase obtained after adding water and/or an aqueous solution in the downstream vessel and separation thereof from a second phase in a centrifuge, as hereinabove mentioned. Examples are specified in the above mentioned WO2017/111602, included by reference.

Advantageously, a weight ratio of solvent, preferably ethylene glycol, to the polymer is in the range of from 10:10 to 100:10, more preferably from 20:10 to 90:10, and most preferably from 40:10 to 60:10.

In a preferred embodiment of the invention, a polymer concentration in the dispersion is 1-30 wt. % of the total weight of the reaction mixture.

A reusable catalyst that is capable of degrading the polymer into oligomers and at least one monomer is being provided to the reaction mixture. The invention may be carried out using any catalyst suitable for the purpose.

In a depolymerization method according to an embodiment, the catalyst forms a dispersion in the reaction mixture during step c.

Recently, quite some attention has been paid to nanoparticles as a depolymerization catalyst. Reactions in the liquid phase require small particles, because the diffusion rate in liquids is smaller by several orders of magnitude, compared to gaseous diffusion rates. Such nanoparticles have a small diameter and a surface area of in the range of from 0.5 up to 200 m²/g. Nanoparticles are highly active, which is believed to result in faster depolymerization and therewith an economically feasible process. To separate such nanoparticles a number of options are available. Several of the possible depolymerization catalysts are based on ferromagnetic and/or ferrimagnetic materials. Also anti-ferromagnetic materials, synthetic magnetic materials, paramagnetic materials, superparamagnetic materials, such as materials comprising at least one of Fe, Co, Ni, Gd, Dy, Mn, Nd, Sm, and preferably at least one of O, B, C, N, such as iron oxide, such as ferrite, such as magnetite, hematite, and maghemite can be used. While the use of magnetic materials principally allows separation by means of magnetic attraction, many nanoparticles are so small that they may not be attracted sufficiently on their own. However, by applying a magnetic field, the nanoparticles may form magnetic clusters, which are separated more easily by magnetic forces. The generation of larger-sized clusters of nanoparticles might also be done by addition of other compounds, for both magnetic and non-magnetic nanoparticle catalysts. An improved solution is offered by the present invention.

One class of suitable catalysts includes the transition metals, in their metallic or ionic form. The ionic form includes free ions in solutions and in ionic bonds or covalent bonds. Ionic bonds form when one atom gives up one or more electrons to another atom. Covalent bonds form with interatomic linkage that results from the sharing of an electron pair between two atoms. The transition metal may be chosen from the first series of transition metals, also known as the 3d orbital transition metals. More particularly, the transition metal is chosen from iron, nickel and cobalt. Since cobalt however is not healthy and iron and nickel particles may be formed in pure form, iron and nickel particles are most preferred. Furthermore, use can be made of alloys of the individual transition metals.

The present nanoparticle is preferably of a magnetic nature, either comprising a magnetic material, or having the ability to be magnetized sufficiently under relatively modest magnetic fields, such as being applied in the present method. Suitably, the magnetic nanoparticles contain an iron, nickel and/or cobalt, in their oxidic or metallic form, or combinations thereof. Iron oxide, for instance but not exclusively in the form of Fe₃O₄ is preferred. Another suitable example is Fe₂O₃. From the alloys a suitable example is CoFe₂O₄. Other preferred examples are NiFe₂O₄, Ni₂Fe₂O₅ or NiO. If a nanoparticle is made of metal it may be provided with an oxide surface, which may further enhance catalysis. The oxide surface may be formed by itself, in contact with air, in contact with water, or the oxide surface may be applied deliberately.

It has been found that the nanoparticles should be sufficiently small for the catalyst complex to function as a catalyst, therewith degrading the polymer into smaller units, wherein the yield of these smaller units, and specifically the monomers thereof, is high enough for commercial reasons. It has further been found that the nanoparticles should be sufficiently large in order to be able to reuse by recovering the present catalyst. It is economically unfavorable that the catalyst would be removed with either waste or degradation product obtained. Suitable nanoparticles have an average diameter in the range of from 2 up to 500 nm, more preferably in the range of from 3 up to 200 nm, even more preferably from 4 up to 100 nm. It has been found that e.g. in terms of yield and recovery of catalyst complex a rather small size of particles of 5-10 nm is optimal. It is noted that the term “size” relates to an average diameter of the particles, wherein an actual diameter of a particle may vary somewhat due to characteristics thereof. In addition aggregates may be formed e.g. in the solution. These aggregates typically have sizes in a range of 50-200 nm, such as 80-150 nm, e.g. around 100 nm. It is preferred to use nanoparticles comprising iron oxide.

Particle sizes and a distribution thereof can be measured by light scattering, for instance using a Malvern Dynamic light Scattering apparatus, such as a NS500 series. In a more laborious way, typically applied for smaller particle sizes and equally well applicable to large sizes representative electron microscopy pictures are taken and the sizes of individual particles are measured on the picture. For an average particle size, a number weight average may be taken. In an approximation the average may be taken as the size with the highest number of particles or as a median size. Most preferred is the use of iron or iron-containing particles. Besides that iron or iron-containing particles are magnetic, they have been found to catalyze the depolymerization of PET for instance to conversion rates into monomer of 70-90% within an acceptable reaction time of at most 6 hours, depending on catalyst loading and other processing factors such as the PET/solvent ratio. The needed concentration of catalyst is 1 wt % relative to the amount of PET or less. Good results also have been achieved with a catalyst loading below 0.2 wt % and even below 0.1 wt % relative to the amount of PET. Such a low loading of the catalyst is highly beneficial, and the invented method allows to recovering an increased amount of the nanoparticle catalyst.

Non-porous metal particles, in particular transition metal particles, may be suitably prepared by thermal decomposition of carbonyl complexes such as iron pentacarbonyl and nickel tetracarbonyl.

Alternatively, iron oxides and nickel oxides may be prepared via exposure of the metals to oxygen at higher temperatures, such as 400° C. and above. A non-porous particle may be more suitable than a porous particle, since its exposure to the alcohol may be less, and therefore, the corrosion of the particle may be less as well, and the particle may be reused more often for catalysis. Furthermore, due to the limited surface area, any oxidation at the surface may result in a lower quantity of metal-ions and therewith a lower level of ions that are present in the product stream as a contaminant to be removed therefrom.

Non-porous according to the invention are particles with a surface area suitably less than 10 m²/g, more preferably at most 5 m²/g, even more preferably at most 1 m²/g. The porosity is suitably less than 102 cm³/g or even less for instance at most 10-3 cm³/g.

Another class of suitable catalysts includes nanoparticles based on earth alkali element selected from beryllium (Be), magnesium (Mg), calcium (Ca), strontium (Sr) and barium (Ba), and their oxides. A preferred earth alkali metal oxide is magnesium oxide (MgO). Other suitable metals include but are not limited to titanium (Ti), zirconium (Zr), manganese (Mn), zinc (Zn), aluminum (Al), germanium (Ge) and antimony (Sb), as well as their oxides, and further alloys thereof. Also suitable are precious metals, such as palladium (Pd) and platinum (Pt). MgO and ZnO have been found to catalyze the depolymerization of PET for instance to conversion rates into monomer of 70-90% within an acceptable reaction time, depending on catalyst loading and other processing factors such as the PET/solvent ratio. Suitable catalysts based on hydrotalcites are also considered.

Preferably, the nanoparticles are selected so as to be substantially insoluble in the (alcoholic) reactive solvents, also at higher temperatures of more than 100° C. Oxides that readily tend to dissolve at higher temperatures in an alcohol such as ethylene glycol, such as for instance amorphous SiO₂, are less suited.

The suitable catalysts according to the invention might be coated. For example, Fe₃04-particles might be coated with a material to protect the particles from oxidation to Fe₂O₃ comprising different magnetic properties. Thus the surface of the catalyst particles might be coated with a material like, polyethyleneimine (PEI), polyethylene glycol (PEG), silicon oil, fatty acids like oleic acid or stearic acid, silane, a mineral oil, an amino acid, or polyacrylic acid or, polyvinylpyrrolidone (PVP). Carbon is also possible as coating material.

The coating might be removed before or during the catalytic reaction. Ways to remove the coating might be for example by using a solvent wash step separately before using it in the reactor, or by burning it in air.

A particularly preferred catalyst relates to a catalyst complex (ABC), which comprises three distinguishable elements: a (nano) particle (A), a bridging moiety/linking group (B) attached to the particle chemically, such as by a covalent bond, or physically, such as by adsorption, and a catalyst entity (C) that is associated with the particles (A), such as by being chemically bonded, for instance covalently bonded, to the linking group. The linking group preferably does not fully cover the nanoparticle surface, such as in a core-shell particle. The nanoparticles of this catalyst complex are preferably based on ferromagnetic and/or ferrimagnetic materials. Also anti-ferromagnetic materials, synthetic magnetic materials, paramagnetic materials, superparamagnetic materials, such as materials comprising at least one of Fe, Co, Ni, Gd, Dy, Mn, Nd, Sm, and preferably at least one of 0, B, C, N, such as iron oxide, such as ferrite, such as magnetite, hematite, and maghemite can be used. In view of costs, even when fully or largely recovering the present catalyst complex, relatively cheap particles are preferred, such as particles comprising Fe. A further advantage of particles of iron or iron oxides is that they have highest saturation magnetisation, making it more easy to separate the particles via a magnetic separator. And even more importantly, the iron oxide nanoparticles have a positive impact on the degradation reaction. The iron oxide may further contain additional elements such as cobalt and/or manganese, for instance CoFe₂04.

Preferably, the nanoparticles are selected so as to be substantially insoluble in the (alcoholic) reactive solvents, also at higher temperatures of more than 100° C. Oxides that readily tend to dissolve at higher temperatures in an alcohol such as ethylene glycol, such as for instance amorphous SiO₂, are less suited.

The functional groups of the bridging moiety are for instance weak organic acid, such as a carboxylic acid or a dicarboxylic acid, but preferably silanols, including silanediols and silanetriols. The bridging moiety may be introduced as a reactant in the form of a silyl comprising group, such as silyl ethers, such as triethoxysilylpropylhalide. The linking group is for instance an alkylene chain, with the alkylene typically between C₂ and C₁₀, preferably C₃-C₅, i.e. propylene, butylene, pentylene. Propylene is preferred. The bridging moiety is suitably provided as a reactant, in which the linking group is functionalized for chemical reaction with the catalyst entity, whereas the functional group may be protected. For instance, a suitable functionalization of the linking group is the provision as a substituted alkyl halide. A suitable protection of the functional group may be in the form of an ester or alkoxysilane. The alkoxy-group is preferably ethoxy, though methoxy or propoxy are not excluded.

In one further embodiment, the alkoxysilane is provided as a trialkoxysilane, having one alkylene group that constitutes the linking group. In an alternative embodiment, use is made of dialkyl-dialkoxysilanes, with one of the alkyl groups being the linking group. In again another embodiment, use is made of monoalkoxy-trialkylsilanes, with one of the alkyl groups being the linking group. In the latter cases, the alkyl groups are preferably lower alkyl, such as C₁-C₄ alkyl, thus methyl, ethyl, propyl, n-butyl, isobutyl. At least one of the alkyls is then functionalized, for instance with a halide, as specified above. Linear alkyls appear preferable to limit steric hindrance.

The use of a dialkyl-dialkoxysilane and/or a monoalkoxy-trialkylsilane is understood to be beneficial to create a better separation between the hydrophilic solution and a second phase in an embodiment, and to ensure that the complex enters the second phase in an embodiment using phase separation, rather than the hydrophilic solution, where it will be lost. It is believed that not all alkoxy-groups of the trialkoxysilanes bond to the surface of the nanoparticle aggregate. Some of the alkoxygroups may even remain protected. The protective groups may however be removed upon addition of water to the complex. As a result, the hydrophilicity of the complex may increase. By using silanes with less alkoxy-groups, the remaining groups are inherently non-polar and cannot become unprotected. The entire complex thus becomes more hydrophobic. Rather than merely one type of bridging moiety, also known as a silane coupling agent, a mixture of those may be used, for instance a mixture of alkyltrialkoxysilane and dialkyl-dialkoxysilane, wherein one of the alkyl-groups is functionalized as a halide to react to the catalytic entity, and subsequently —after the reaction of both—carries the catalytic entity. The addition of dialkyldialkoxysilanes may well reduce the size of the layer of groups bonded to the surface. This is not deemed a disadvantage.

The moiety may be aromatic or aliphatic, and heterocyclic. An aromatic heterocyclic moiety suitably comprises a heterocycle having at least one, preferably at least two nitrogen atoms. The heterocycle may have 5 or 6 atoms, preferably 5 atoms. Suitable aromatic heterocycles are pyrimidines, imidazoles, piperidines, pyrrolidine, pyridine, pyrazol, oxazol, triazol, thiazol, methimazol, benzotriazol, isoquinol and viologen-type compounds (having f.i. two coupled pyridine-ring structures). Particularly preferred is an imidazole structure, which results in an imidazolium ion. The negatively charged moiety may relate to an anionic complex, but alternatively a simple ion, such as a halide. Preferably, the reaction of the alkylhalide of the bridging moiety with an uncharged aromatic heterocyclic moiety including at least one nitrogen atom generates the positive charge on the aromatic moiety, particularly on the nitrogen atom therein, as well as the creation of the negative halide. The negatively charged halide may thereafter be strengthened by addition of a Lewis acid to form a metal salt complex. One example is the conversion of chloride to FeCl₄⁻. The aromatic moiety has in one example at least one tail. The at least one tail preferably has a length of C₁-C₁₀, such as C₂-C₄, the at least one tail suitably being attached to a nitrogen atom. This tail is more particularly a tail extending into the carrier liquid and away from the bridging moiety. A longer tail is deemed beneficial to increase the hydrophobicity of the complex. This may counteract tendencies of complex to enter the hydrophilic phase.

According to the present invention, the bridging moiety and the catalyst entity bonded thereto are provided in an amount of (mole bridging moiety/gr magnetic particle) 5*10⁻⁶-0.1, preferably of 1*10⁻⁵-0.01, more preferably of 2*10⁻⁵-10⁻³, such as 4*10⁻⁵-10⁻⁴. It is preferred to have a relatively large amount available in terms of an effective optional recovery of the catalyst complex, whereas, in terms of amount of catalyst and costs thereof, a somewhat smaller amount may be more preferred.

It has been found that limited coverage of the surface of the nanoparticles, or aggregate of such particles, with the catalyst group is sufficient to obtain an effective catalyst. It is assumed that if a predetermined amount (moles) of bridging moiety is attached to a predetermined amount (gr) practically all of the bridging moieties attach to the nanoparticle and substantially stay attached during the present method.

In step c of the method degrading of the polymer occurs in the reaction mixture at reaction conditions using the catalyst to form monomers. The reaction mixture is preferably heated to a suitable temperature which is preferably maintained during depolymerization. The temperature may be selected in the range of from 170° C. to 250° C. In preferred embodiments, the degrading step may comprise forming the monomer at a temperature in the range of from 185° C. to 225° C. Suitable pressures in the reactor are from 1-5 bar, wherein a pressure higher than 1.0 bar is preferred, and more preferably lower than 3.0 bar.

The catalyst, to the extent that it is not dissolved in the solvent but heterogeneous, can be recovered to a large extent. In step d the catalyst is recovered from the reaction mixture. Separation occurs for instance in a centrifuge. The presence of any aggregates is deemed advantageous, as it may render the phase separation more effective.

The method comprises furthermore the addition of at least one base to at least one of the reaction steps a, b, c or d. The effect of the addition of the base is that the degradation reaction of the polymer to its oligomers and monomers is improved by reduction of the reaction time, and/or reduction of the formation of by-products. The base can be added to step a, together with the polymer or with the solvent, or separately. The base might be added as a solid, or dissolved in water or in a solvent, depending on the nature of the base. In case a non-volatile base is used, it is preferred to add the base in solid form or at least partly dissolved in the solvent already used in step a of the method. In case a volatile base is being added, it is preferably dissolved in water or in the solvent of the reaction mixture. The base can also be added in step b of the method, together with the reusable catalyst or separately. It can furthermore be added in step c of the method, before or during the degradation of the polymer in the reaction mixture.

The base can also be added in step d of the method, before or during the recovery of the catalyst from the reaction mixture. The base has an effect on the separation of the catalyst from the reaction mixture. Separation is improved and the catalyst is recovered more easily.

The amount of base added to the reaction mixture relative to the amount of catalyst ranges preferably from 0.1:1 to 40:1, more preferably from 1:1 to 35:1, and most preferably from 2:1 to 5:1.

Advantageously, water is added to the reaction mixture prior to or during the recovery of the catalyst. Water can be added separately or together with the base. The step of adding water with or without the base with said reaction mixture, results in a first aqueous phase comprising monomer and dimer, and a second phase comprising oligomer, catalyst complex and aggregates, and separating the first phase from the second phase. This has turned out an effective manner to remove various contaminants. In a preferred implementation hereof, the second phase is processed to reduce its water content and thereafter recycled into the reactor vessel. The reduction of water content may be carried out in several ways, for instance by means of evaporation, such as by distillation and/or membrane distillation.

The recovering step according to the method preferably comprises separating the catalyst from the reaction mixture. The separation step is more preferably performed using a centrifuge.

Alternatively, the separation step is preferably performed using magnetic separation and/or application of electric field. In the preferred embodiment with water being added to the reaction mixture the separation is preferably performed at a temperature of between 60° C. and 100° C., more preferably of between 75° C. and 95° C. If no water is present, separation can be performed at higher temperatures.

Advantageously, water or aqueous solution that is added to the reaction mixture prior to or during the recovery of the catalyst may act as coolant. It may be provided at ambient temperature or any higher temperature and is preferably liquid. Still, it is not excluded that separate cooling means are provided. Due to the addition of water or an aqueous solution, two phases will appear, of which the first is an aqueous phase comprising solvent, monomer and at least some dimer and trimer. The second phase is a slurry comprising a variety of solids, including catalyst, oligomers, trimers and the solvent.

The water added to the reaction mixture in step d is preferably in an amount such that the weight ratio of water to solvent ranges from 0.2 to 5.0, more preferably from 0.5 to 1.5, even more preferably from 0.7 and 1.3, and most preferably from 0.9 and 1.1. The more water is added, the more precipitation of catalyst and oligomers generally takes place. However, this also generally means that more water needs to be distilled to isolate or reuse the catalyst and oligomers.

In the preferred embodiment that both base and water is being added, the weight ratio of base to water ranges then from 0.01 to 1.0, more preferably from 0.05 to 0.5, and most preferably from 0.08 to 0.12. Preferably, the water and/or base is added in an amount to increase the pH of the reaction mixture to above 6.

The amount of catalyst relative to the amount of polymer is rather low. Preferably, it ranges from 0.001:10 to 1:10, more preferably from 0.005:10 to 0.3:10, and most preferably from 0.008 to 0.015:10.

The base that is being added to at least one of the reaction steps is preferably a volatile base comprising an aqueous solution of ammonia and/or trialkylamines. Suitable amine containing compounds are for instance disclosed in WO2015056377A1, which is expressly incorporated herein as far as the listed amine containing compounds is concerned. It is advantageous to use a volatile base, as the water phase is being recycled, and less or no elemental contamination of the product is observed.

In an alternative embodiment, the base that is being added to the reaction mixture prior to or during the recovering of the catalyst is preferably a non-volatile base comprising a metal hydroxide. More preferably, the metal hydroxide comprises lithium hydroxide (LiOH), sodium hydroxide (NaOH), potassium hydroxide (KOH), rubidium hydroxide (RbOH), cesium hydroxide (CsOH), magnesium hydroxide (Mg(OH)), calcium hydroxide (Ca(OH)), strontium hydroxide (Sr(OH)), barium hydroxide (Ba(OH)), tetramethylammonium hydroxide (N(CH3)4OH), potassium tert-butoxide, sodium bicarbonate and guanidine (HNC(NH2)2).

If the base is a non-volatile base comprising a metal hydroxide, the base is preferably added in step a or in step b of the process. It is furthermore possible to additionally add a non-volatile or a volatile base to step d of the process to improve the recovery of the catalyst from the reaction mixture. The base can thus be the same base, or it can be that the base added in step d is a volatile base. The base added in step a or b functions as a co-catalyst for the depolymerisation reaction.

The depolymerisation speed increases due the presence of the base, and also the formation of by-products is supressed.

In accordance with other embodiments of the invention, the recovering step d is preferably performed directly after the water and/or base addition.

In an embodiment of the invention, the addition of water and a base to the reaction mixture prior to or during the recovering of the catalyst in step d is performed at a temperature below 160° C., preferably below 100° C. It is advantageous to perform this addition at the lower temperatures, for optimal aggregate formation and oligomer precipitation.

Advantageously, after the degrading step the reaction mixture is cooled to below 170° C. before the water and/or base adding step. The water is preferably water at a temperature of at least 85° C.

The present invention is furthermore directed to the use of a base as described above, as a co-catalyst for the catalyst for degrading the polymer in the reaction mixture. The base is active in the reaction and since it preferably stays in the system, it might be of influence in both the depolymerisation reaction as well as the recovery of the catalyst.

We have found that for example, NaOH is a promising co-catalyst, as the addition of NaOH increases the activity of the depolymerisation catalyst in the depolymerisation reaction, while the production of for example BHEET remains the same. Also the separability of the catalyst improves with the addition of NaOH.

It may be important to avoid producing too much BHEET in the reactor during depolymerization. BHEET is defined by Formula I:

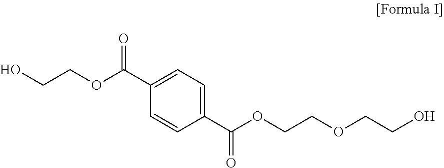 [SMILES: O=C(OCCO)c1ccc(C(=O)OCCOCCO)cc1]

It has turned out that the claimed catalyst, i.e. the reusable catalyst complex being capable of degrading the polymer into oligomers and/or monomers, wherein the catalyst complex comprises preferably a catalyst entity, a metal containing particle, and a bridging moiety for connecting the catalyst entity to the magnetic particle, and a base, produces a decreased amount of BHEET for the same BHET yield, when compared to other catalysts.

### BRIEF DESCRIPTION OF THE FIGURES

The above and other advantages of the features and objects of the invention will become more apparent and the invention will be better understood from the following detailed description when read in conjunction with the accompanying drawings, in which:

FIG. 1 illustrates the separation efficiency of a catalyst with the addition of several bases.

FIG. 2 illustrates the results of experiment 11, the yield of BHET.

FIG. 3 illustrates the formation of the by-product BHEET.

FIG. 4 illustrates the separation efficiency of the ABC catalyst complex with the addition of other bases.

FIG. 5 illustrates the separation efficiency of the ABC catalyst complex with the addition of a specific base.

### DESCRIPTION OF AN EMBODIMENT

The following, non-limiting examples are provided to illustrate the invention.

### Experiments

Comparative Experiment A: separation efficiency—catalyst ABC

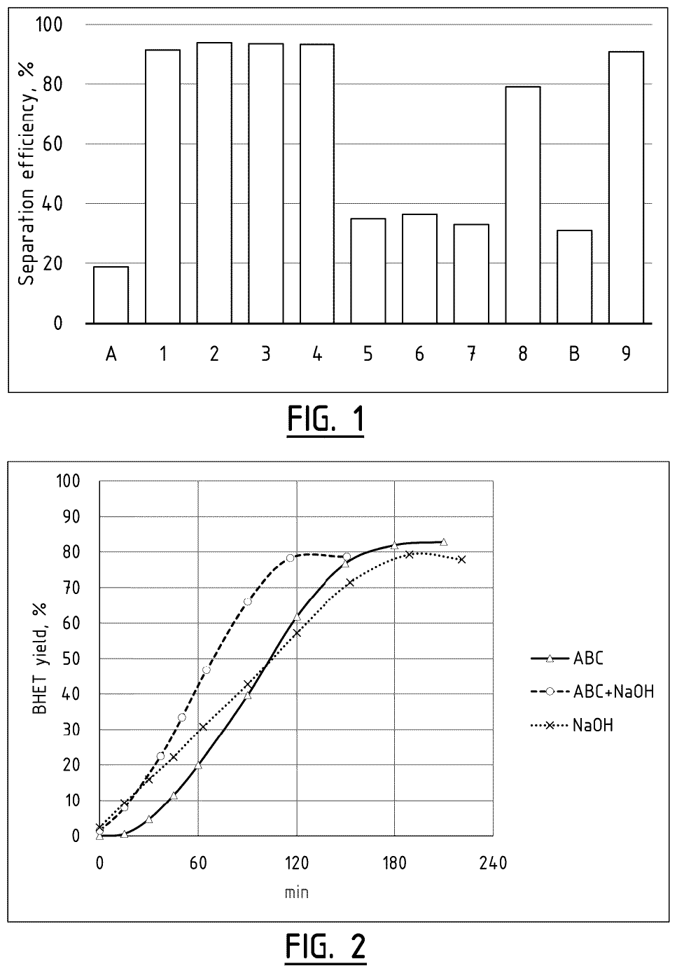

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. The flask was heated to 80-100° C. and mix at that temperature to ensure dissolution of BHET. The depolymerized mixture was transferred to 50-mL centrifuge tubes. The mixture was centrifuged at 4000 rpm for 3 min. The supernatant was separated by decanting and subsequently cooled down to crystallize the BHET product present in the supernatant. BHET crystals were filtered out from the mother liquor using a Bichner filter and dried in a vacuum oven at 60° C. Dry BHET and mother liquor were then analyzed by XRF to estimate the separability of the catalyst from the mixture. The separation efficiency as % of the catalyst present is depicted in FIG. 1.

### Example 1: Separation Efficiency—Catalyst ABC+Ammonia

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. 0.125 g of 28% ammonia solution was added to the mixture. The same procedure of depolymerization reaction described in Comparative Experiment A was used. The separation efficiency as % of the catalyst present is depicted in FIG. 1.

### Example 2: Separation Efficiency—Catalyst ABC+NaOH

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. 0.05 g of sodium hydroxide was added to the mixture. The same procedure of depolymerization reaction described in Comparative Experiment A was used. The separation efficiency as % of the catalyst present is depicted in FIG. 1.

### Example 3: Separation Efficiency—Catalyst ABC+LiGH

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. 0.1 g of lithium hydroxide was added to the mixture. The same procedure of depolymerization reaction described in Comparative Experiment A was used. The separation efficiency as % of the catalyst present is depicted in FIG. 1.

### Example 4: Separation Efficiency—Catalyst ABC+Na₂CO₃

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. 0.5 g of sodium carbonate was added to the mixture. The same procedure of depolymerization reaction described in Comparative Experiment A was used. The separation efficiency as % of the catalyst present is depicted in FIG. 1.

### Example 5: Separation Efficiency—Catalyst ABC+Triethylamine (TEA)

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. 0.5 g of triethylamine was added to the mixture. The same procedure of depolymerization reaction described in Comparative Experiment A was used. The separation efficiency as % of the catalyst present is depicted in FIG. 1.

### Example 6: Separation Efficiency—Catalyst ABC+Tripropylamine (TPA)

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. 0.05 g of tripropylamine was added to the mixture. The same procedure of depolymerization reaction described in Comparative Experiment A was used. The separation efficiency as % of the catalyst present is depicted in FIG. 1.

### Example 7: Separation Efficiency—Catalyst ABC+1-Methyl Imidazole (NMI)

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. 0.05 g of 1-methyl imidazole was added to the mixture. The same procedure of depolymerization reaction described in Comparative Experiment A was used. The separation efficiency as % of the catalyst present is depicted in FIG. 1.

### Example 8: Separation Efficiency—Catalyst ABC+N″-Pentamethyldiethylenetriamine (PMDETA)

Separation experiments were carried out using a 600 ml flask. An amount of 0.017 g of an iron-based ABC catalyst complex was used in combination with 16.7 g of bis(2-Hydroxyethyl) terephthalate (BHET). To the reaction mixture was added 125 g of ethylene glycol (EG) and 125 g of water. 0.5 g of N″-Pentamethyldiethylenetriamine was added to the mixture. The same procedure of depolymerization reaction described in Comparative Experiment A was used. The separation efficiency as % of the catalyst present is depicted in FIG. 1.

### Comparative Experiment B: Separation Efficiency—Fe₃O₄

Separation experiments were carried out using a 600 ml flask. An amount of 0.017 g of Fe₃O₄ was used in combination with 16.7 g of bis(2-Hydroxyethyl) terephthalate (BHET). To the reaction mixture was added 125 g of ethylene glycol (EG) and 125 g of water. The same procedure of depolymerization reaction described in Comparative Experiment A was used. The separation efficiency as % of the catalyst present is depicted in FIG. 1.

### Example 9: Separation Efficiency—Fe₃O₄+NaOH

Separation experiments were carried out using a 600 ml flask. An amount of 0.017 g of Fe₃O₄ was used in combination with 16.7 g of bis(2-Hydroxyethyl) terephthalate (BHET). To the reaction mixture was added 125 g of ethylene glycol (EG) and 125 g of water. 0.05 g of sodium hydroxide was added to the mixture. The same procedure of depolymerization reaction described in Comparative Experiment A was used. The separation efficiency as % of the catalyst present is depicted in FIG. 1.

### Example 10: Depolymerization Reactions

Depolymerization experiments were carried out using a 500 ml round bottom flask. 0.034 g of an iron-based ABC catalyst complex or 0.05 of NaOH or their combination were used with 33.4 g of polyethylene terephthalate (PET) flakes (pieces of 0.3×0.3 cm²) and 250 g of ethylene glycol. The round bottom flask was placed in the heating setup. The heating was started, and after 20 minutes, the reaction mixture had reached the reaction temperature of 197° C. The reaction was followed in time by taking in-process-control samples to measure the concentration of monomer (bis(2-hydroxyethyl) terephthalate, or BHET) and by-products (such as 2-(2-hydroxyethoxy)ethyl (2-hydroxyethyl) terephthalate or BHEET) produced as a function of time. The concentration of BHET and BHEET was determined with HPLC.

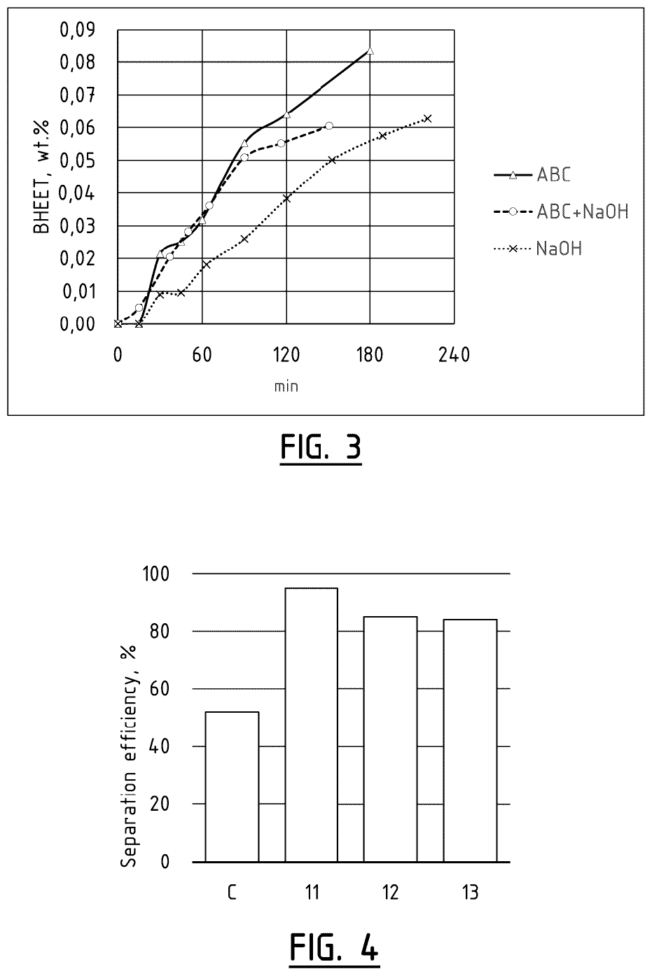

The results are presented in the FIGS. 2 and 3. In FIG. 2 the yield of BHET as function of the reaction time is shown, with various catalyst systems. The ABC catalyst with NaOH as co-catalyst is faster in the conversion of the polymer to BHET. In FIG. 3 the formation of the by-product BHEET as function of the reaction time is shown, with various catalyst systems. The BHEET formation is clearly supressed by the presence of NaOH as cocatalyst.

### Comparative Example C: Separation Efficiency—Catalyst ABC

The same procedure of depolymerization reaction as described in Example 10 was used with 0.034 g of an iron-based ABC catalyst complex. After 240 min at 197° C., the reaction was stopped by cooling down below 160° C. The reaction mixture was transferred to a beaker through a sieve filter to remove the remaining solids. Water was added to obtain the water:EG ratio of 1:1. The mixture was mixed. A sample before centrifuging was taken. The mixture was transferred to centrifuge tubes and centrifuged at 4000 rpm for 3 min. A sample after centrifuging was taken. The samples were analyzed by XRF to estimate separability. The results are shown in FIG. 4.

### Example 11: Separation Efficiency—Catalyst ABC+NaOH and Water

The same procedure of depolymerization reaction as described in Example 10 was used with 0.034 g of an iron-based ABC catalyst complex and 0.05 of NaOH. After 240 min at 197° C., the reaction was stopped by cooling down below 160° C. The reaction mixture was transferred to a beaker through a sieve filter to remove the remaining solids. Water was added to obtain the water:EG ratio of 1:1. The mixture was mixed. A sample before centrifuging was taken. The mixture was transferred to centrifuge tubes and centrifuged at 4000 rpm for 3 min. A sample after centrifuging was taken. The samples were analyzed by XRF to estimate separability. The results are shown in FIG. 4.

### Example 12: Separation Efficiency—Catalyst ABC+NaOH (No Water)

The same procedure of depolymerization reaction as described in Example 10 was used with 0.034 g of an iron-based ABC catalyst complex and 0.05 of NaOH. After 240 min at 197° C., the reaction was stopped by cooling down below 160° C. The reaction mixture was transferred to a beaker through a sieve filter to remove the remaining solids. The mixture was mixed. A sample before centrifuging was taken. The mixture was transferred to centrifuge tubes and centrifuged at 4000 rpm for 3 min. A sample after centrifuging was taken. The samples were analyzed by XRF to estimate separability. The results are shown in FIG. 4.

### Example 13: Separation Efficiency—Catalyst ABC+KOH (No Water)

The same procedure of depolymerization reaction as described in Example 10 was used with 0.034 g of an iron-based ABC catalyst complex and 0.05 of KOH. After 240 min at 197° C., the reaction was stopped by cooling down below 160° C. The reaction mixture was transferred to a beaker through a sieve filter to remove the remaining solids. The mixture was mixed. A sample before centrifuging was taken. The mixture was transferred to centrifuge tubes and centrifuged at 4000 rpm for 3 min. A sample after centrifuging was taken. The samples were analyzed by XRF to estimate separability. The results are shown in FIG. 4.

### Comparative Example D: Catalyst ABC

Depolymerization experiments were carried out using a 600 ml stainless steel high-pressure reactor. 0.4 g of an iron-based ABC catalyst complex was used with 40 g of polyethylene terephthalate (PET) flakes (pieces of 0.1×0.02 cm²) and 300 g of ethylene glycol. The reactor was placed in the heating setup. The heating was started, and after 25 minutes, the reaction mixture had reached the reaction temperature of 210° C. After 240 min at 210° C., the reaction was stopped by cooling down below 160° C. The reaction mixture was transferred to a beaker through a sieve filter to remove the remaining solids. Water was added to obtain the water:EG ratio of 0.8:1. The mixture was mixed. A sample before centrifuging was taken. The mixture was transferred to centrifuge tubes and centrifuged at 4000 rpm for 3 min. A sample after centrifuging was taken. The samples were analyzed by XRF to estimate separability. In FIG. 1 the separation efficiency is shown.

### Example 14: Catalyst ABC+NaOH

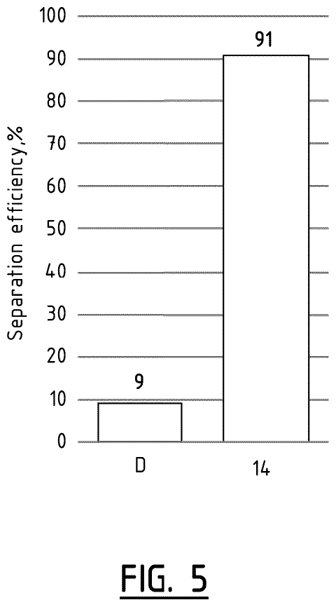

The same procedure of depolymerization reaction as described in Comparative example D was used with 0.4 g of an iron-based ABC catalyst complex and 0.6 of NaOH. FIG. 5 shows the separation efficiency obtained in Comparative example D and Example 14. It turns out that the separation efficiency of the ABC catalyst is increased dramatically with the addition of NaOH, also at a higher reaction temperature of 210° C.

1. A method for obtaining a monomer by degrading a polymer, the polymer being a homo or copolymer of the monomer, the method comprising the steps of
a. providing the polymer and a solvent as a reaction mixture in a reactor, wherein the solvent is a reactant capable of reacting with the polymer to degrade the polymer into oligomers and at least one monomer;
b. providing a reusable catalyst being capable of degrading the polymer into the oligomers and the at least one monomer;
c. degrading the polymer in the reaction mixture at reaction conditions using the catalyst to form the at least one monomer; and
d. recovering the catalyst from the reaction mixture;
wherein the method further comprises the addition of at least one base to the reaction mixture in at least one of the reaction steps a to d.

2. Method as claimed in claim 1, wherein water is added to the reaction mixture prior to or during the recovery of the catalyst.

3. Method as claimed in claim 2, wherein the water is added to the reaction mixture in an amount such that the weight ratio of water to solvent ranges from 0.2 to 5.0, preferably from 0.5 to 1.5, more preferably from 0.7 and 1.3, and even more preferably from 0.9 and 1.1.

4. Method as claimed in claim 2, wherein the base is added to the reaction mixture in an amount such that the weight ratio of base to water ranges from 0.01 to 1.0, preferably from 0.05 to 0.5, and more preferably from 0.08 to 0.12.

5. Method as claimed in claim 1, wherein the amount of catalyst relative to the amount of polymer ranges from 0.001:10 to 1:10, preferably from 0.005:10 to 0.3:10, and more preferably from 0.008 to 0.015:10.

6. Method as claimed in claim 5, wherein the base is added to the reaction mixture in an amount relative to the amount of catalyst ranging from 0.1:1 to 40:1, preferably from 1:1 to 35:1, and more preferably from 2:1 to 5:1.

7. Method as claimed in claim 1, wherein the base is a volatile base comprising an aqueous solution of ammonia and/or trialkylamines.

8. Method as claimed in claim 1, wherein the base is a non-volatile base comprising a metal hydroxide.

9. Method as claimed in claim 8, wherein the metal hydroxide comprises at least one of lithium hydroxide (LiOH), sodium hydroxide (NaOH), potassium hydroxide (KOH), rubidium hydroxide (RbOH), cesium hydroxide (CsOH), magnesium hydroxide (Mg(OH)), calcium hydroxide (Ca(OH)), strontium hydroxide (Sr(OH)), barium hydroxide (Ba(OH)), tetramethylammonium hydroxide (N(CH₃)40H), and guanidine (HNC(NH₂)2).

10. Method as claimed in claim 7, wherein the base is added in step a or in step b.

11. Method as claimed in claim 2, wherein water is added to the reaction mixture prior to the recovery of the catalyst in step d.

12. Method as claimed in claim 1, wherein after the degrading step the reaction mixture is cooled to below 170° C.

13. Method as claimed in claim 2, wherein the addition of water to the reaction mixture prior to or during the recovering of the catalyst in step d is performed at a temperature below 160° C., preferably below 100° C.

14. Method as claimed in claim 1, wherein the base is added in an amount to increase the pH of the reaction mixture to above 6.

15. Method as claimed in claim 1, wherein the recovering step comprises separating the catalyst from the reaction mixture.

16. Method as claimed in claim 15, wherein the separation step is performed using a centrifuge.

17. Method as claimed in claim 15, wherein the separation step is performed using magnetic separation and/or application of electric field.

18. Method as claimed in claim 15, wherein the separation is performed at a temperature of between 60° C. and 100° C., preferably of between 75° C. and 95° C.

19. Method as claimed in claim 1, wherein the reusable catalyst comprises a catalyst complex comprising a catalyst entity, a metal containing nanoparticle, and a bridging moiety connecting the catalyst entity to the magnetic nanoparticle, wherein the catalyst entity comprises a cationic moiety having a positive charge, and an anionic moiety, having a negative charge, and preferably providing a negative counterion.

20. Method as claimed in claim 1, wherein a weight ratio of solvent, preferably ethylene glycol, to the polymer is in the range of from 20:10 to 100:10, more preferably from 40:10 to 90:10, and most preferably from 60:10 to 80:10.

21. Method as claimed in claim 1, wherein a polymer concentration in the dispersion is 1-30 wt. % of the total weight of the reaction mixture.

22. Method as claimed in claim 1, wherein the degrading step c comprises forming the monomer at a temperature higher than 170° C., and preferably at most 250° C., at a pressure higher than 1.0 bar, and preferably lower than 3.0 bar.

23. Use of a base as claimed in claim 7 as a co-catalyst for a catalyst for degrading a polymer in a reaction mixture at reaction conditions.

24. Use according to claim 23, wherein the base is a non-volatile base.

25. Use according to claim 23, as a co-catalyst for the catalyst as claimed in claim 19.
